(19) United States
(12) Patent Application Publication
(10) Pub. No.: US 2013/0003966 A1
(43) Pub. Date: Jan. 3, 2013

(54) Cryptographic hardware module and method for updating a cryptographic key

(76) Inventors: Markus Ihle, Kusterdingen (DE); Robert Szerwinski, Esslingen (DE); Jamshid Shokrollahi, Ludwigsburg (DE); Jan Hayek, Muenchen (DE); Martin Emele, Stuttgart (DE)

(21) Appl. No.: 13/505,407

(22) PCT Filed: Oct. 13, 2010
(86) PCT No.: PCT/EP2010/065327

§ 371 Date: Sep. 14, 2012

(30) Foreign Application Priority Data
Nov. 5, 2009 (DE) 102009046436.0

(51) Int. Cl. H04L 9/00

(52) U.S. Cl. 380/44; 380/277

(57) ABSTRACT

A cryptographic hardware module has an arithmetic unit, a memory storing at least one first key, a logic and a cryptographic device. The hardware module loads at least one second encrypted key into the hardware module and decrypts the at least one second encrypted key via the cryptographic device using the at least one first key.

### BACKGROUND OF THE INVENTION

1. Field of the Invention

The present invention relates to a cryptographic hardware module and a method for updating a cryptographic key.

2. Description of Related Art

Implementing security protocols in environments in which physical security is not ensured requires the use of hardware security modules to secure the cryptographic keys. Depending on the application, this hardware must meet certain security requirements. There are different approaches proposed in the related art for this purpose, for example, the Trusted Platform Module (TPM), see, for example, published German patent application document DE-11 2005 003 502.

### BRIEF SUMMARY OF THE INVENTION

Using the cryptographic hardware module and the method according to the present invention, it is possible to update secret keys in a secure hardware module or to use them for encrypting and decrypting, the secret keys never being accessible to the firmware of the microprocessor of the hardware module, thus being particularly secured. Furthermore, the proposed method and the proposed device have a flexible design, so that different cryptographic operations may be performed.

In one particular embodiment, the key to be decrypted is stored encrypted outside the hardware module in a memory and is loaded into the hardware module via a communication link for decrypting. The advantage of this is that the key to be decrypted may be stored outside of the cryptographic hardware security module in an encrypted form without violating security requirements.

It is particularly advantageous if a logic module or possibly a logic module of the cryptographic hardware module prevents the encrypted keys from getting from the hardware module onto an open communication link, for example, onto a data bus.

In another advantageous embodiment, the cryptographic device of the hardware module is equipped for enabling it to perform various cryptographic procedures, for example, standard procedures such as AES (Advanced Encryption Standard), MAC (Message Authentication Code, for example, CMAC) or CBC (Cipher Block Chaining) to ensure the most flexible use possible of the hardware module.

It is also advantageous if the cryptographic device of the hardware module has means for deriving or generating secret keys from secret information, i.e., for having key derivation functions KDF.

### BRIEF DESCRIPTION OF THE DRAWINGS

FIG. 1 schematically shows a hardware security module HSM.

FIG. 2 shows an exemplary embodiment of a hardware security module HSM.

### DETAILED DESCRIPTION OF THE INVENTION

In the description, the terms hardware module, cryptographic module, and hardware security module (HSM) are used largely as synonyms. The cryptographic modules available until now are based either on hardwired hardware state machines or on programmable microprocessors. State machines provide a higher degree of protection, while software approaches may be updated in the event of failures or new applications. In the latter case, it has previously been necessary that the user trust the manufacturer of the firmware or the firmware, since it has access to the secret keys. This represented a problem, in particular at the time of each update, in that each new version had to be completely and independently certified.

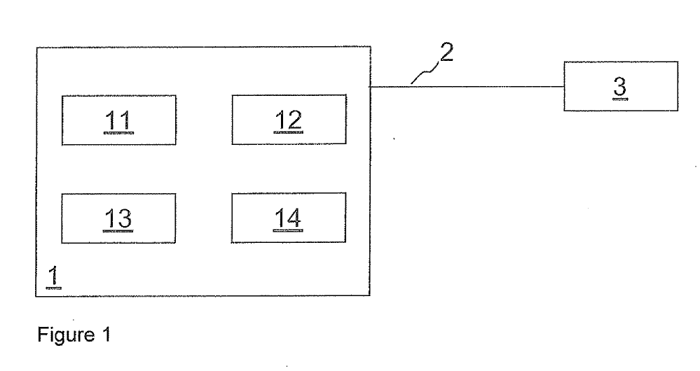

FIG. 1 schematically shows a hardware security module HSM 1 having an arithmetic unit 11, an (internal) memory 12, a cryptographic device 13, and a logic 14. Furthermore, FIG. 1 shows a communication link 2 and an (external) memory 3. HSM 1 is connected to memory 3 via communication link 2. In this embodiment, let's assume that a first key “parent key” is stored in memory 12 and at least one encrypted key, “child key,” is stored in memory 3. The encrypted “child key” may be decrypted using the “parent key.” In special embodiments of the HSM shown in FIG. 1, arithmetic unit 11 may be implemented as a microprocessor, for example, memory 12 as a register, logic 14 as a state machine, or communication link 2 as a data bus.

Logic 14 may now load the encrypted “child key” from memory 3 into hardware module 1 via communication link 2. Cryptographic device 13 then decrypts the “child key” with the aid of the “parent key” from memory 12. The decrypted “child key” is stored in memory 12.

One advantage of this procedure is that secret keys, here the “child key,” may be stored in an encrypted form in a non-volatile memory, here memory 3, outside the HSM without the decrypted “child key” and “parent key” being known to the firmware or being transferred via the general communication link during the update. According to this proposed approach, the keys may be updated using standard key update protocols, which preserve the confidentiality and integrity of the keys.

For the update of the lower-level key, here the “child key,” the higher-level key, here the “parent key,” must be known within the HSM.

Multiple separate hierarchic contexts are possible here for cryptographic keys. Lower-level keys are stored encrypted in the system and possibly decrypted in the HSM; higher-level keys are stored in the HSM.

In the following, a detailed implementation of the cryptographic system and method is described using an exemplary hardware architecture.

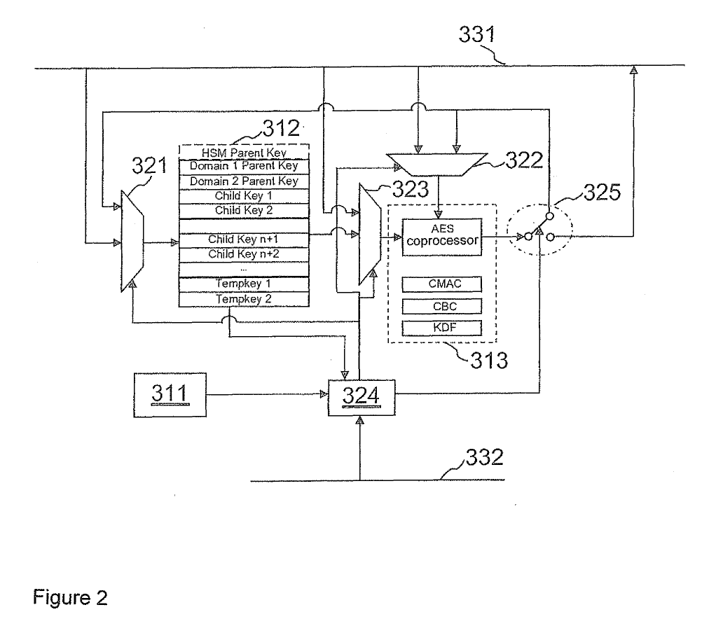

FIG. 2 shows a hardware architecture as an exemplary embodiment, which meets the above-mentioned requirements. A computer 311 (HSM CPU) is connected to a key security circuit 324. Key security circuit 324 is also connected to address bus 332, data isolation switch 325, key memory 312, key memory multiplexer 321, data multiplexer 322, and key multiplexer 323. Data multiplexer 322 and key multiplexer 323 have access to cryptographic module 313. Cryptographic module 313 is, in addition, connected to data isolation switch 325. The data isolation switch is also connected to data bus 331, data multiplexer 322, and key memory multiplexer 321. Data bus 331 is connected to key memory multiplexer 321, data multiplexer 322, and key multiplexer 323. Key memory 312 is connected to key memory multiplexer 321 and key multiplexer 323. Cryptographic module 313 has a coprocessor (AES coprocessor) and is, in addition, capable of different cryptographic operations (CMAC, CBC, KDF). KDF (key derivation function) enables the derivation of keys; CMAC and CBC are used for decrypting depending on the encryption algorithm. Higher-level keys (“parent keys”), possibly lower-level keys (“child keys”) and temporary keys (“tempkeys”) are stored in key memory 312. The “tempkeys” are temporarily stored keys; in the case of a domain structure, for example, they are also domain-independent keys. In a domain structure, the highest-level key, “HSM master key,” is stored or burned in key memory 312. Using KDF, for example, higher-level “parent keys” may be derived for different domains from the HSM master key: for example, domain 1 “parent key” and domain 2 “parent key.” The owners of domain 1 and domain 2 do not know either the keys of the other particular domains or the HSM master key; thus, these are two parallel, cryptographically separated domains. In particular, no domain is able to update the keys of another domain using a key known to it.

Key memory 312 of FIG. 2 is a possible embodiment of memory 12 of FIG. 1; logic 321, 322, 323, 324, 325 also represents a logic 14 of FIG. 1; data bus 331 corresponds to communication link 2, microprocessor 311 corresponds to arithmetic unit 11, and key module 313 corresponds to cryptographic device 13. Logics 14 and 321-5 and cryptographic devices 13 and 313 may each be provided as a module (as shown in FIG. 2 for the cryptographic device) or as individual components (as shown in FIG. 2 for the logic). The basic principle according to this embodiment is again the following: Microprocessor 311 may start a loading operation of an encrypted key “child key,” which is loaded from an external memory into the cryptographic hardware module, i.e., HSM, here specifically into the key module or into cryptographic device 313, via data bus 331 and data multiplexer 322. Cryptographic device 313 decrypts the encrypted “child key” using the “parent key,” the “parent key” being loaded from memory 312 via key multiplexer 323. Controlled by the logic module or key security circuit 324, cryptographic device 313 transfers the decrypted “child key” to memory 312 via the logic module or data isolation switch 325, via the logic module or key memory multiplexer 321. Key security circuit 324 is responsible for preventing data isolation switch 325 from transferring the decrypted “child key” to data bus 331, i.e., prevents attacks intended to trigger the transfer of the decrypted “child key” to data bus 331. The decrypted “child key” is then stored in memory 312.

Key memory 312 is a memory within the HSM and may have ROM and RAM areas. Key memory multiplexer 321 decides whether selected keys should be written on data bus 331 according to [their] values or to an output of the AES coprocessor. Key multiplexer 323 determines the key from key memory 312, and also determines the loading procedure from data bus 331 into the key input of the AES coprocessor, the latter for keys which are not to be protected in this hierarchy. Data multiplexer 322 is connected to the data input of the AES coprocessor and loads the input either from data bus 331 or from the output of the AES coprocessor. Data isolation switch 325 does not allow any of the keys decrypted by the AES coprocessor to appear on data bus 331; this is controlled by key security circuit 324 as described above. Circuits CMAC and KDF have state machines, circuit logics, and registers, which control the AES coprocessor for implementing CMAC and KDF algorithms. Each key is provided with a flag, which determines to which domain this key belongs. This flag is set automatically as a function of its address when the key is loaded. This flag is used by key security circuit 324 for deciding whether or not the command from HSM CPU 311 is allowed and conflicts with the security specifications of the hardware module. The loaded keys are encrypted. They are loaded via data bus 331, decrypted using the appropriate higher-level “parent key” or “domain master key,” but then they are not transferred to data bus 331, but written to the right location of key memory 312. Domain master keys may be located in the ROM of hardware module key memory 312 or they may be generated instantaneously with the aid of the KDF functionality. The latter requires that a CPU master key (“HSM master key”) be stored in the ROM of key memory 312. This “HSM master key” is not known to the domain owners, who know only the result of the key derivation function having appropriate constants for their own domains. Keys must be stored in such a way that their authenticity can be guaranteed. This may be done in different ways, for example, by providing each key with a message authentication code MAC.

When keys are updated, temporary keys are generated with the aid of the above-described architecture (FIG. 2) and used for executing the key update algorithm. As described previously, one advantage of this proposed approach is that the keys are not transmitted via the data bus unencrypted, they are not available to any other domain, and also do not need to be known to the firmware. In the special key hierarchy, in order to update any key, the knowledge of this key or of one of its higher-level keys is necessary.

Any method that guarantees the secrecy and integrity of the keys may be used for updating the keys. Since such methods are based on the secrecy and integrity of the intermediate values which are generated and used during the method, one advantage of the present module is that these values are not known or accessible to the owners of other domains.

1-9. (canceled)

10. A cryptographic hardware module, comprising:
an arithmetic unit;
a memory storing at least one first key;
a logic device; and
a cryptographic device;
wherein at least one second, encrypted key is loaded into the cryptographic device via the logic device, and wherein the at least one second encrypted key is decrypted by the cryptographic device using the at least one first key.

11. The cryptographic hardware module as recited in claim 10, wherein at least two first keys are generated from a master key and assigned to two different domain owners, and wherein the two different domain owners do not know the master key and the first key of the other domain owner.

12. The cryptographic hardware module as recited in claim 10, wherein the hardware module loads the second, encrypted key from an external memory via a communication link.

13. The cryptographic hardware module as recited in claim 12, wherein the logic device of the cryptographic hardware module is configured to prevent (i) the first key from being transferred in a decrypted form and (ii) the second key from being transferred in a decrypted form via the communication link.

14. The cryptographic hardware module as recited in claim 13, wherein the cryptographic device is configured to perform cryptographic operations according to at least one of Advanced Encryption Standard, Message Authentication Code, and Cipher Block Chaining.

15. The cryptographic hardware module as recited in claim 13, wherein the cryptographic device is configured to derive secret keys from secret information.

16. A method for performing a key update in a cryptographic hardware module, comprising:
storing at least one first key in the cryptographic hardware module;
loading at least one second, encrypted key into the cryptographic hardware module via a logic device of the cryptographic hardware module; and
decrypting the at least one second, encrypted key by a cryptographic device of the cryptographic hardware module using the at least one first key.

17. The method as recited in claim 16, wherein the at least one second, encrypted key is loaded from an external memory via a communication link.

18. The method as recited in claim 16, wherein at least two first keys are generated from a master key and assigned to two different domain owners, and wherein the two different domain owners do not know the master key and the first key of the other domain owner.
